(19) United States
(12) Patent Application Publication
(10) Pub. No.: US 2012/0250043 A1
(43) Pub. Date: Oct. 4, 2012

(54) IMAGE FORMING APPARATUS, IMAGE FORMING METHOD, AND NON-TRANSITORY COMPUTER READABLE MEDIUM STORING IMAGE FORMING PROGRAM

(75) Inventors: Hidetoshi KAWASHIMA, Kanagawa (JP); Atsushi KITAGAWARA, Kanagawa (JP); Yuichi NISHIKUNI, Kanagawa (JP); Toshio KORIYAMA, Kanagawa (JP)

(73) Assignee: FUJI XEROX CO., LTD., Tokyo (JP)

(21) Appl. No.: 13/247,789

(22) Filed: Sep. 28, 2011

(30) Foreign Application Priority Data
Mar. 28, 2011 (JP) 2011-070236

(51) Int. Cl. H04N 1/60

(52) U.S. Cl. 358/1.9

(57) ABSTRACT

An image forming apparatus includes a two-color printing unit that prints a document image in two colors, a specific image adding unit that adds a specific image to the document image when the document image is printed in two colors, a printing unit that performs a printing process with color materials which are used to print the document image and the specific image in two colors, and an interrupt processing unit that performs an interrupt process of adding print information containing color materials of the specific image different from the document image such that the specific image is conspicuous in the document image before the printing process.

### CROSS-REFERENCE TO RELATED APPLICATIONS

This application is based on and claims priority under 35 USC 119 from Japanese Patent Application No. 2011-070236 filed Mar. 28, 2011.

### BACKGROUND

### Technical Field

The present invention relates to an image forming apparatus, an image forming method, and a non-transitory computer readable medium storing an image forming program.

### SUMMARY

According to an aspect of the invention, there is provided an image forming apparatus including: a two-color printing unit that prints a document image in two colors; a specific image adding unit that adds a specific image to the document image when the document image is printed in two colors; a printing unit that performs a printing process with color materials which are used to print the document image and the specific image in two colors; and an interrupt processing unit that performs an interrupt process of adding print information containing color materials of the specific image different from the document image such that the specific image is conspicuous in the document image before the printing process.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Exemplary embodiments of the present invention will be described in detail based on the following figures, wherein:

FIG. 1 is a block diagram illustrating the overall structure of an image forming apparatus according to an exemplary embodiment of the invention in which an image forming program is installed;

FIG. 2 is a diagram illustrating the structure of an image forming unit according to the exemplary embodiment;

FIG. 3A is a diagram illustrating a printout of a document image, which is an application target of the exemplary embodiment of the invention;

FIG. 3B is a diagram illustrating a printout of the document image before the exemplary embodiment of the invention is applied;

FIG. 3C is a diagram illustrating a printout of the document image after the exemplary embodiment of the invention is applied;

FIG. 4 is a functional block diagram illustrating a process performed on the basis of a control program according to the exemplary embodiment;

FIG. 5 is a diagram illustrating a setting panel, which is an example of a user interface, when a color is designated in a control process according to the exemplary embodiment;

FIGS. 6A and 6B are diagrams illustrating a drop-down menu when a color is designated in detail in the setting panel;

FIG. 7 is a diagram illustrating a designating panel when a color is designated in detail in the setting panel;

FIG. 8 is a diagram illustrating a list of patterns that can be designated when a pattern process is performed on the shape of a specific image in the control process according to the exemplary embodiment;

FIG. 9 is a diagram illustrating examples of the pattern shapes; and

FIG. 10 is a flowchart illustrating the control process according to the exemplary embodiment.

### DETAILED DESCRIPTION

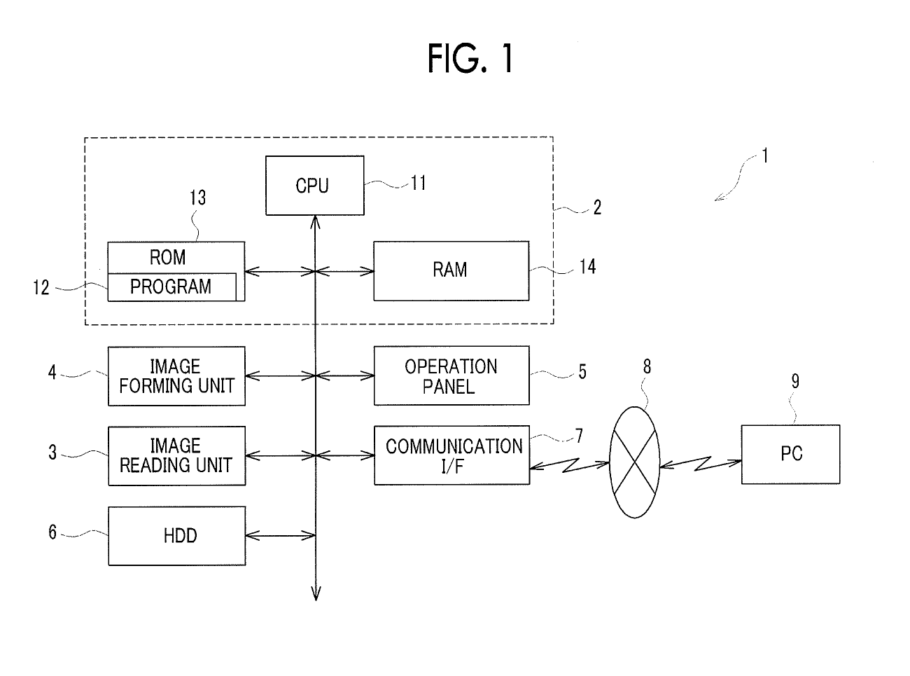

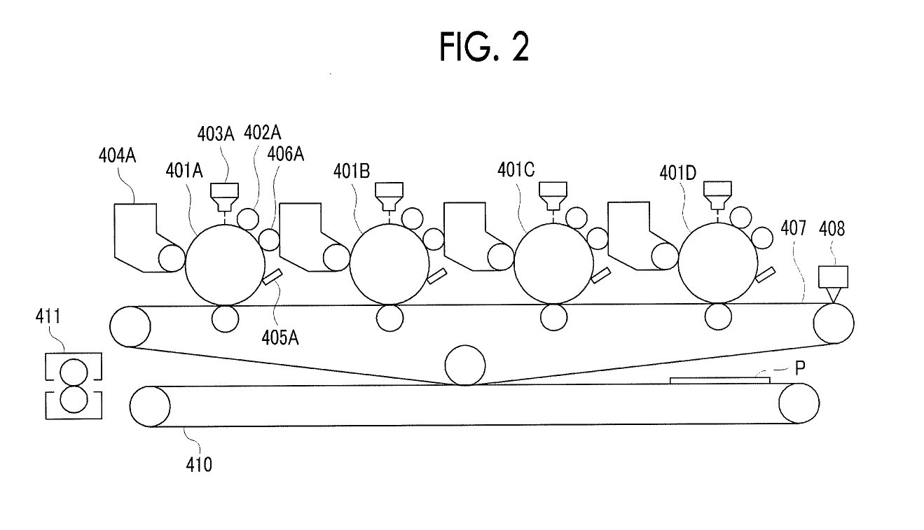

Hereinafter, exemplary embodiments of the invention will be described in detail with reference to the accompanying drawings. FIGS. 1 to 10 are diagrams illustrating an image forming apparatus according to an exemplary embodiment of the invention in which an image forming program is installed.

In FIG. 1, in an image forming apparatus 1 according to this exemplary embodiment, a control unit 2 that intensively controls each unit of the image forming apparatus is connected to an image reading unit 3 that emits reading light to a document sheet, receives reflected light corresponding to an image of the document, converts the reflected light into an electric signal, and optically reads image data, an image forming unit (printing unit) 4 that forms an image on a print medium, such as a recording sheet, on the basis of the received image data, using an electrophotographic recording method, an operation panel 5 that is used by the user to perform various kinds of operations, a magnetic storage device (HDD) 6 that stores data other than the image data, and a communication I/F (interface) 7 that communicates with an external PC (personal computer) 9 through a network 8.

The control unit 2 performs various kinds of operations using various parameters and a RAM 14 as a work area according to various kinds of control programs 12 which are stored in a ROM 13 by a CPU 11, thereby generally controlling each unit of the apparatus. The control unit 2 directs the image forming unit 4 to form an image on a recording sheet P, which is a print recording medium, on the basis of the image data of the document image which is read by the image reading unit 3 in response to plural requests from the operation panel 5 or the image data of the document image which is received as a print request from the external PC 9 through the communication I/F 7. The control program 12 may be set up in a ROM 13 in advance at the time when the image forming apparatus 1 is manufactured. The control program 12 may be read from a recording medium storing the control program 12 and then set up in a non-volatile memory which is a portion of the HDD 6 or the ROM 13. Alternatively, the control program 12 may be downloaded in the form of carrier waves from a communication path, such as the Internet, through the communication I/F 7 and then set up in a non-volatile memory which is a portion of the HDD 6 or the ROM 13.

The image forming unit 4 is capable of forming a color image on the recording sheet P on the basis of the image data of the document image using a tandem electrophotographic recording method and includes four drum-shaped photoconductors 401A, 401B, 401C, and 401D which are provided around an intermediate transfer belt 407. Various kinds of devices for forming an image using an electrophotographic process are provided around each of the photoconductors 401A, 401B, 401C, and 401D. These devices have the same structure in the photoconductors 401A, 401B, 401C, and 401D. Therefore, as a representatively example, the devices provided around the photoconductor 401A will be described below.

First, the following devices are provided around the photoconductor 401A: a charging device 402A that charges the surface of the photoconductor 401A; a print head 403A that forms an electrostatic latent image on the charged surface of the photoconductor 401A on the basis of image data; a developing device 404A that selectively attaches toner, which is a developer, to the electrostatic latent image on the surface of the photoconductor 401A to develop the image; a cleaner 405A that collects the toner remaining on the surface of the photoconductor 401A after the toner image is transferred to the intermediate transfer belt 407, which will be described below; and a neutralization device 406A that neutralizes the surface of the photoconductor 401A from which the remaining toner is collected. A toner image is formed on the photoconductor 401A with a yellow (Y) developer (in the following description, the photoconductors 401 indicate the photoconductors 401A, 401B, 401C, and 401D. The same holds for the charging device 402A, the print head 403A, the developing device 404A, the cleaner 405A, and the neutralization device 406A). Similarly, magenta (M), cyan (C), and black (K) toner images are formed on the photoconductors 401B, 401C, and 401D, respectively. The toner images on the surface of the photoconductors 401 are transferred to the intermediate transfer belt 407 so as to overlap each other on the basis of a detection signal of a registration sensor 408 while being positioned. Then, the toner images are collectively transferred to the recording sheet P, which is a print medium. Then, the recording sheet P is transferred to the fixing device 411 by a sheet transfer belt 410 and the images are fixed to the recording sheet P. In this way, a color image is formed. The image forming apparatus 1 is an exemplary embodiment of a processing apparatus according to the invention and is not limited to the electrophotographic recording type. This exemplary embodiment of the invention may be applied to other types of image forming apparatuses. For example, this exemplary embodiment of the invention may be applied to an image forming apparatus of an ink-jet recording type that forms a document image on a print medium, such as the recording sheet P.

The image forming apparatus 1 has a copy and print function. That is, the control unit 2 receives a copy request from the operation panel 5 and the image reading unit 3 reads the image data of a document image. Then, the image forming apparatus 1 receives the image data. Alternatively, the image forming apparatus 1 receives a print request from the external PC 9 through the communication I/F 7, receives the image data of a document image, and controls the CPU 11 to execute the control program 12. In this case, when performing the copy and print function, the control unit 2 of the image forming apparatus 1 may select one of the full color print mode in which it performs a printing process on the basis of image data so as to print a document image in full color and the two-color print mode in which it performs a printing process of processing image data so as to print a document image in two colors, that is, black and any one of blue, red, magenta, and cyan.

The image forming apparatus 1 also has a stamp printing function in which the control unit 2 receives a print request to add a specific image including an arbitrarily formed figure as well as a specific image of, for example, the characters “Confidential”, “For Internal Use Only”, or “Important” or a specific image of, for example, a symbol “*”, which is prepared in advance or is input from the external PC 9, to the document image at the same time as the request to copy and print the document image (hereinafter, simply referred to as a print request) is received and the CPU 11 executes the control program 12, thereby forming an image. That is, the control unit 2 forms an interrupt processing unit.

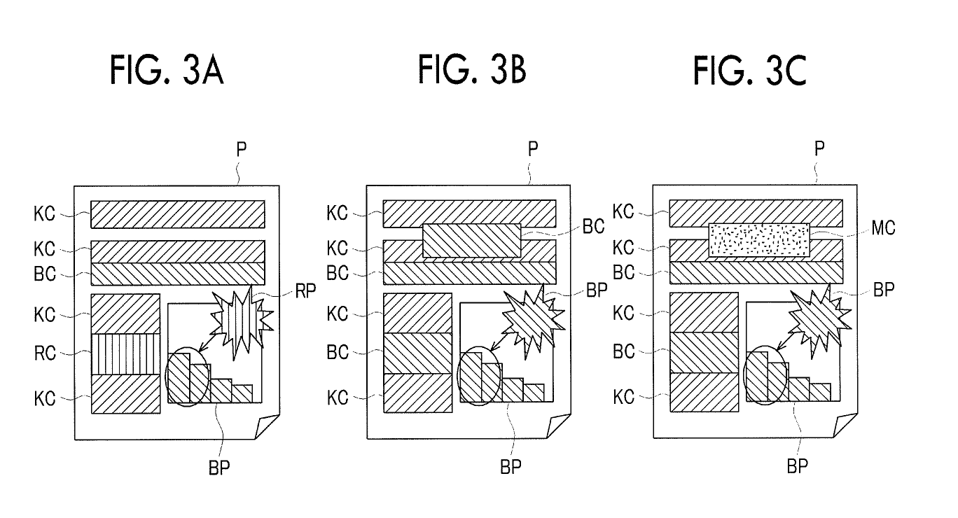

In this case, when an instruction to perform the stamp printing function in the two-color print mode of black and blue is given, for example, it is assumed that specific blue characters (specific image) BC are added to a document image including black characters KC, blue characters BC, red characters RC, a blue image BP, and a red image RP, as shown in FIG. 3A. However, as shown in FIG. 3B, the black characters KC, the blue characters BC, and the blue image BP are not changed, but the red characters RC and the red image RP are respectively converted into the blue characters BC and the blue image BP so as not to be conspicuous.

However, as shown in FIG. 3C, since blue is formed by mixing cyan (C) and magenta (M) toners, for example, specific magenta characters (specific image) MC are additionally formed by toner having magenta (M) as a principal component so as to be conspicuous in the document image. Similarly, although not shown in the drawings, since red is formed by mixing yellow (Y) and magenta (M) toners, the specific magenta characters (specific image) MC are additionally formed by toner having magenta (M) as a principal component so as to be conspicuous in the document image. Since green is formed by mixing cyan (C) and yellow (Y) toners, specific cyan characters (specific image) CC or specific yellow characters (specific image) YC are additionally formed by toner having cyan (C) or yellow (Y) as a principal component such that the specific image is conspicuous in the document image. Each of the specific magenta characters MC, the specific yellow characters YC, and the specific cyan characters CC or the specific yellow characters YC may be formed by one principal color toner.

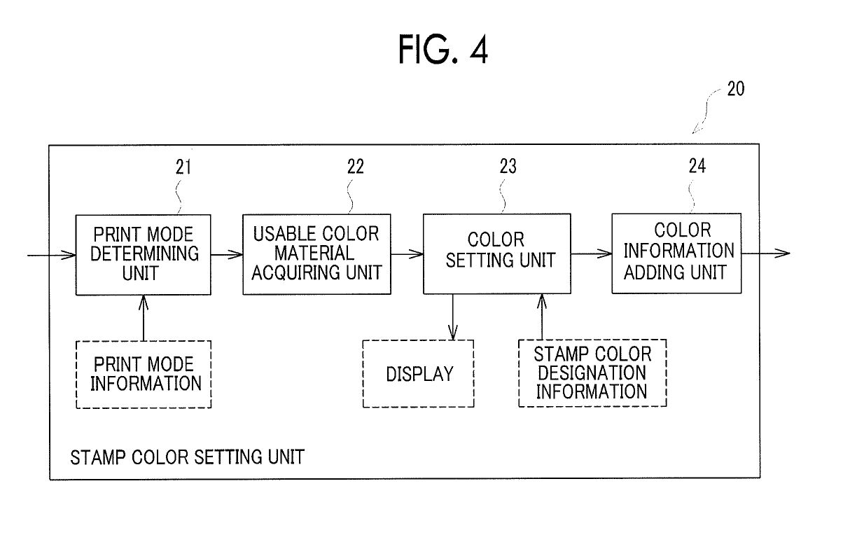

In this exemplary embodiment, the CPU 11 executes a control process according to the control program 12 in the ROM 13 such that the control unit 2 serves as a stamp color setting unit 20 including a print mode determining unit 21, a usable color material determining unit 22, a color setting unit 23, and a color information adding unit 24, as shown in FIG. 4. Next, an example in which a document image print request to add a specific image of the characters “Important” is received from the external PC 9 will be described. The image forming apparatus 1 may perform the stamp printing function of adding a specific image to the document image in the two-color print mode (copy and print) and the operation panel 5 may be used to perform the following selection operation.

First, when a request to print the document image (image data) and a stamp print request to add a specific image to the document image are received, the print mode determining unit 21 determines the full color print mode or the two-color print mode. When the two-color print mode is determined, the usable color material determining unit 22 acquires color material information for printing the document image. When the two-color print mode is selected and black and blue or red are used, the color setting unit 23 transmits a setting panel 50, which will be described below, to the external PC 9 and displays the setting panel 50 on a monitor (not shown) such that the user sets how to use the acquired use color material information in order to print the specific image. In addition, the color setting unit 23 receives the color information (stamp color designation information) of the specific image to be printed by the stamp printing function which is selected by the external PC 9. The color information adding unit 24 adds the color material information (for example, color mixture conditions which will be described below) of the specific image which will be added to the document image and printed to print information on the basis of the selected color information of the specific image.

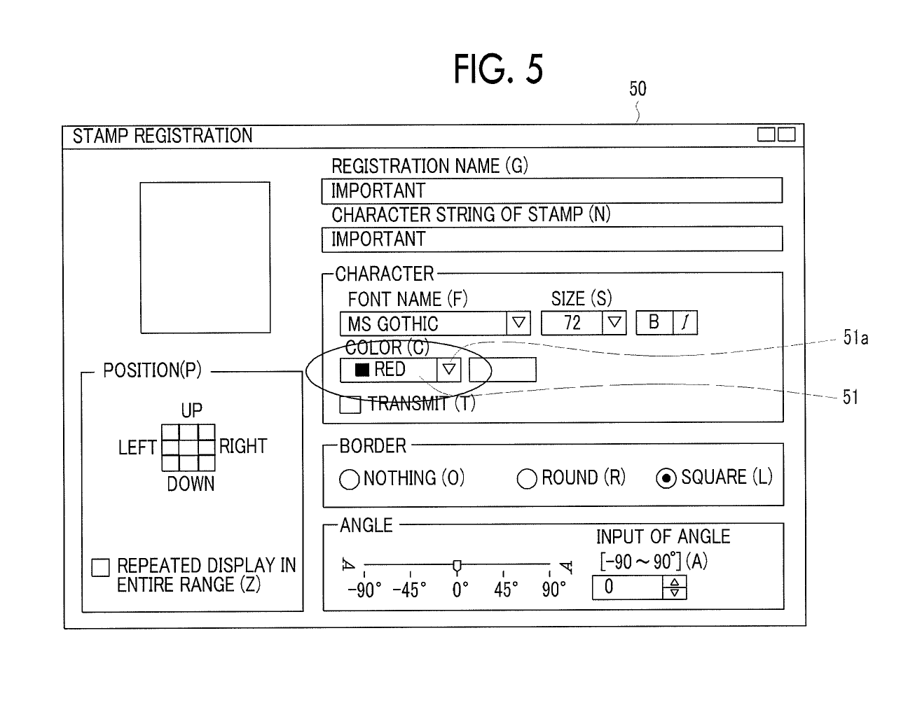

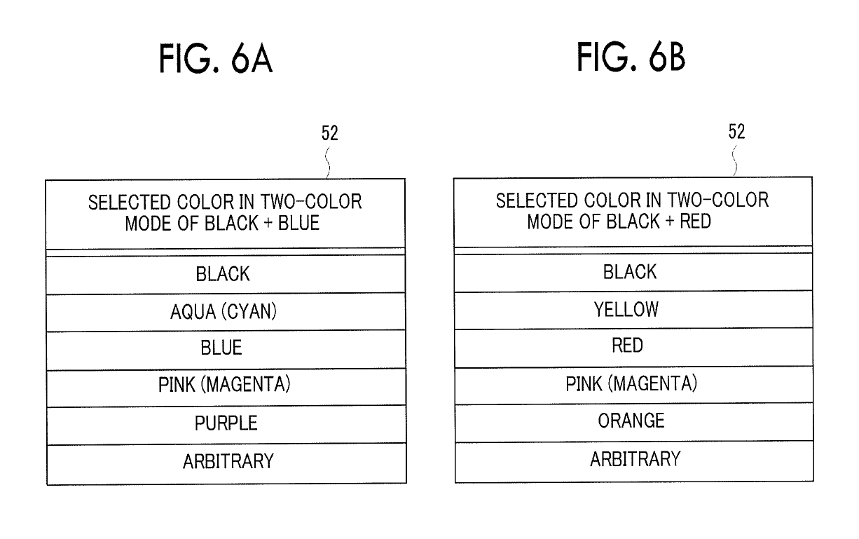

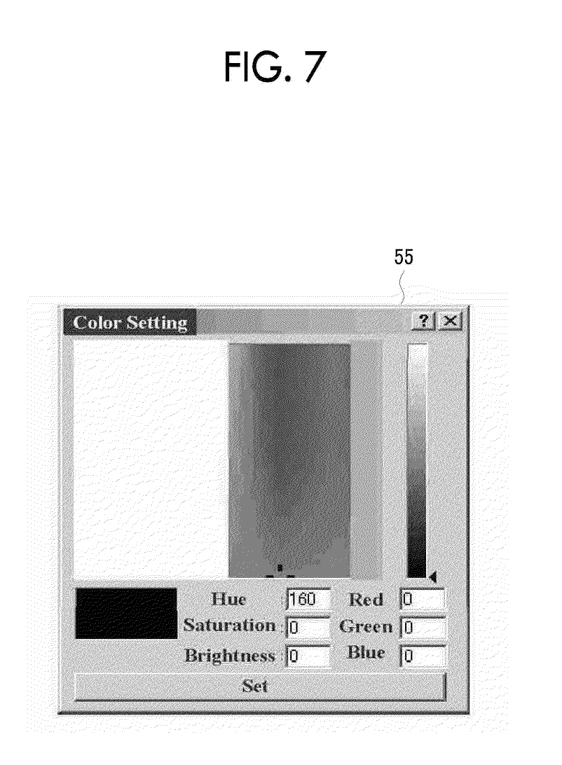

As shown in FIG. 5, the setting panel 50 transmitted to the external PC 9 by the color setting unit 23 (the control unit 2, which is the same in the following description) includes fields for inputting a position where a specific image is added, characters, the font and size of the characters, a field for setting a border, and a window 51 for designating a color. When a down mark 51a is clicked, the color designation window 51 displays a drop-down menu 52 shown in FIGS. 6A and 6B such that a color can be selected, and displays the selected color. As shown in FIG. 6A, in the two-color print mode of black and blue, the drop-down menu 52 displays “black”, “aqua (cyan)”, “blue”, “pink (magenta)”, “purple”, and “arbitrary” so as to be selectable. When “arbitrary” is selected, a designating panel 55 for designating the degree (ratio) of color mixture between “cyan” and “magenta” is transmitted to the external PC 9 and is then displayed on the monitor (not shown), as shown FIG. 7. In addition, the color setting unit 23 receives color mixture designation information (stamp color designation information). In addition, as shown in FIG. 6B, in the two-color print mode of black and red, the drop-down menu 52 displays “black”, “yellow”, “red”, “pink”, “orange”, and “arbitrary” so as to be selectable. In this way, it is possible to print the specific image of the characters “Important” in a color different from that in the document image so as to be conspicuous. In this exemplary embodiment, colors for printing the specific image are arbitrarily designated. However, the stamp printing process may be performed in colors that are reproducible by the color materials used in the two-color print mode, for example, “aqua”, “purple”, “magenta”, and “orange”. In the stamp printing process when a document image is printed in full color, the same setting panel may be used to designate the mixture of colors for forming a specific image. The stamp printing process is performed on the specific image added to the document image on the basis of the stamp color designation information.

When the two-color print mode is selected and black and cyan or magenta are used, the acquired use color material information is of the colors of the color materials to be used and may not be of the other colors. Therefore, the color setting unit 23 transmits a list 60 with a check box 61, which will be described below, to the external PC 9 and displays the list 60 on the monitor (not shown) such that the user selects the pattern shape (conspicuous shape) of the specific image of the characters “Important” which will be added to the document image. In this case, similarly, the color setting unit 23 receives the color information (stamp color information) of the specific image printed by the stamp printing function which is selected by the external PC 9. The color information adding unit 24 adds the color material information (the same color) of the specific image, which will be added to the document image and then printed, to the print information on the basis of the selected color information of the specific image (one color other than black).

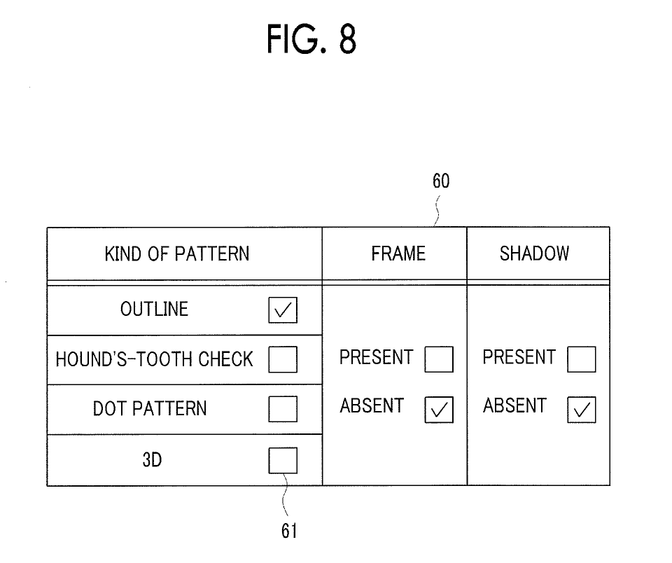

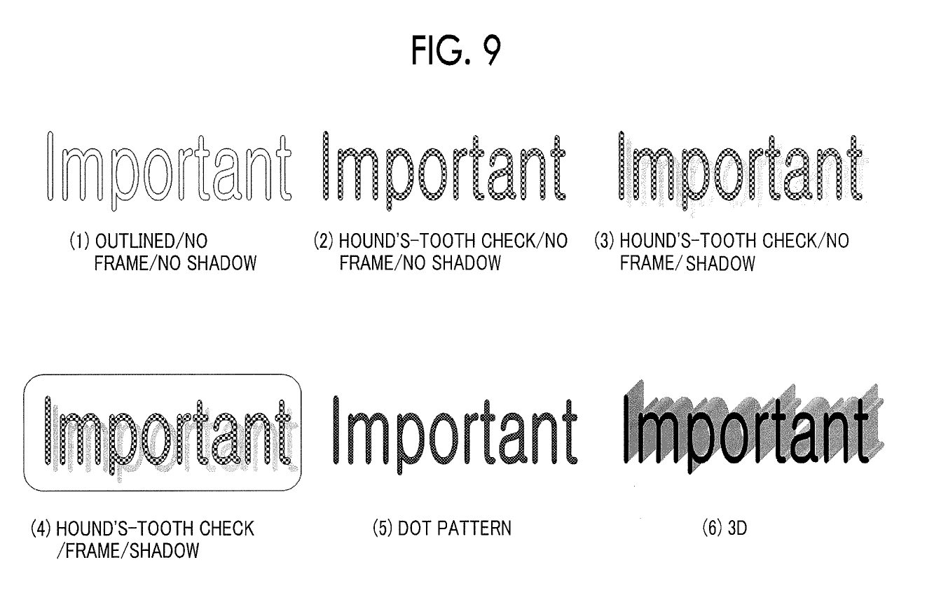

As shown in FIG. 8, the list 60 transmitted to the external PC 9 by the color setting unit 23 is displayed such that the user can select a pattern shape making the specific image conspicuous with the check box 61 according to the document image and the user can select whether to set a frame or shadow with the check box 61. For example, as shown in FIG. 9, the specific image of the characters “Important” is displayed in pattern shapes having characteristic patterns and outlines, such as (1) outline/no frame/no shadow, (2) hound's-tooth check/no frame/no shadow, (3) hound's-tooth check/no frame/shadow, (4) hound's-tooth check/frame/shadow, (5) dot pattern, and (6) 3D, so as to be conspicuous in the document image of the same color.

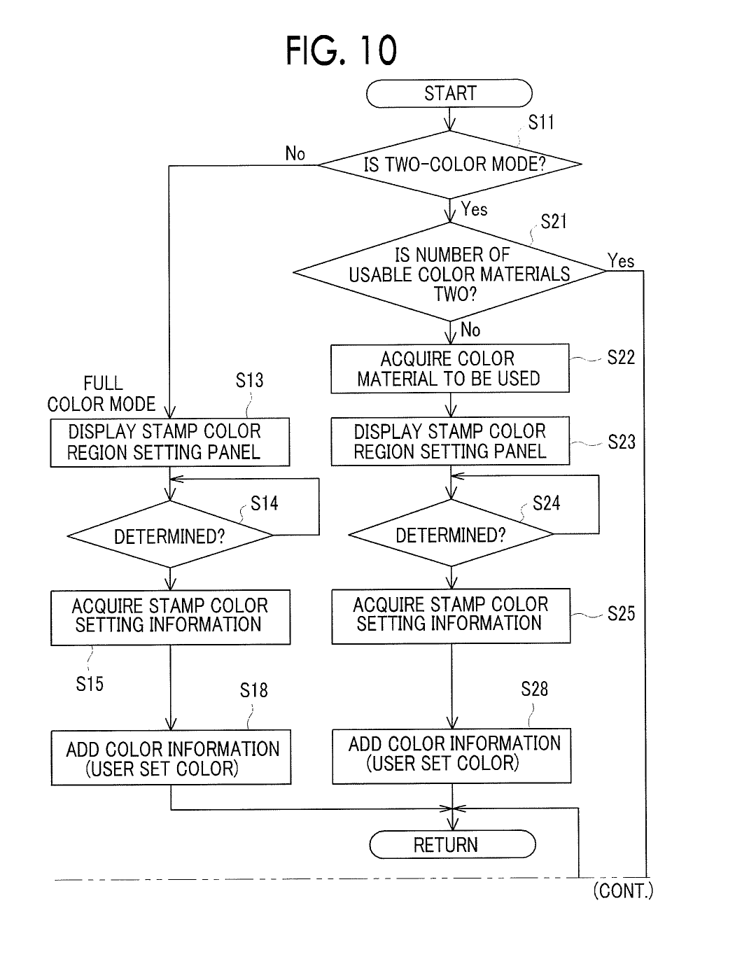

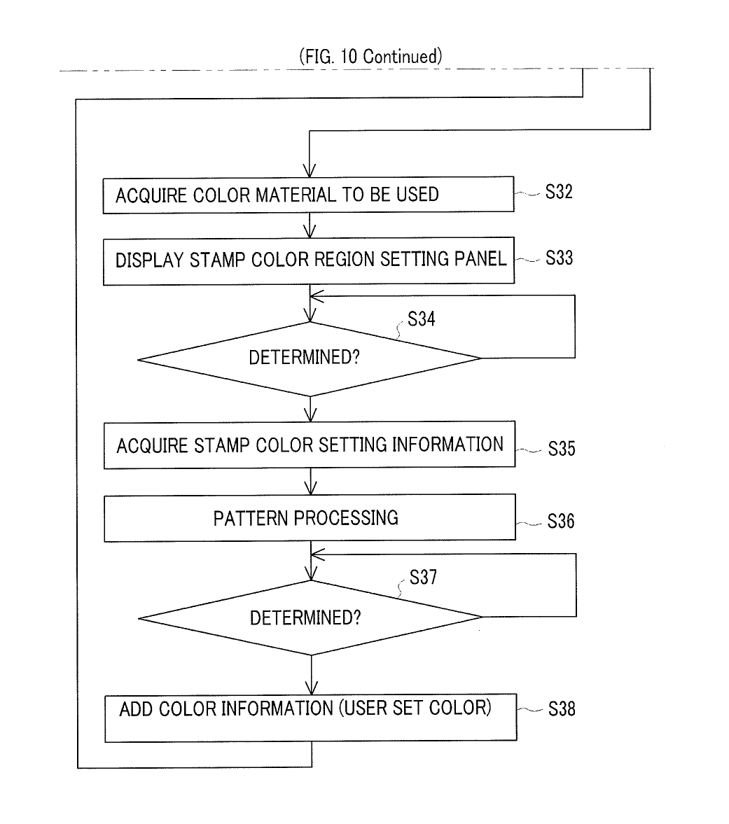

In this way, the image forming apparatus 1 may perform the process shown in the flowchart of FIG. 10 to print the document image such that the specific image of the characters “Important” is conspicuous in the document image and the user can effectively recognize the handling of a printout (a copy during a copying process). In this exemplary embodiment, the stamp printing process is performed in the two-color print mode. Therefore, the two-color print mode will be mainly described below.

Specifically, first, when a request to print a document image (image data) is received from the external PC 9 and the stamp printing process is selected, the print mode determining unit 21 determines whether the print mode is the two-color print mode (Step S11). When it is determined that the print mode is not the two-color print mode, that is, the print mode is the full color print mode, the color setting unit 23 transmits the setting panel 50 shown in FIG. 5 to the external PC 9 and displays it on the monitor since the usable color material determining unit 22 does not need to acquire usable color material information (Step S13). Red is displayed in the color designation window 51 of the setting panel 50 so as to be designated in advance. In this state, when the user of the external PC 9 inputs the position where a specific image is added, the characters “Important”, the font or size of the characters “Important”, and whether to set a border and then clicks a confirmation button (OK) (Step S14), the red color information is acquired as the print color of the specific image of the characters “Important” (Step S15).

In Step S14, when the user who wants to change the color clicks the down mark 51a of the color designation window 51, a list of colors that can be selected is displayed in the same drop-down menu as that shown in FIGS. 6A and 6B and the color information of the color of the characters “Important” selected by the user is acquired. When “arbitrary” is selected from the list, the same designating panel as that shown in FIG. 7 is transmitted to the external PC 9 and is then displayed on the monitor. When the user inputs, for example, the color mixture ratio of “cyan”, “magenta”, and “yellow”, the designated color mixture information (stamp color information) of the characters “Important” is acquired.

Then, the color information adding unit 24 adds the color material information of the specific image, which will be added to the document image and then printed, to the print information on the basis of the acquired color information (Step S18). Then, the process returns to the printing process of the document image and the specific image.

In Step S11, when the print mode determining unit 21 determines that the print mode is the two-color print mode, it is checked whether one color which is used to print the document image together with black includes two color materials (Step S21). When two color materials are usable, the usable color material determining unit 22 acquires the information of the two color materials which are used to print the document image together with black (Step S22). Then, the setting panel 50 shown in FIG. 5 is transmitted to the external PC 9 and is then displayed on the monitor (Step S23). Red is displayed in the color designation window 51 of the setting panel 50 so as to be designated in advance. In this state, when the user of the external PC 9 inputs the position where a specific image is added, the characters “Important”, the font or size of the characters “Important”, and whether to set a border and then clicks the confirmation button (OK) (Step S24), the red color information is acquired as the print color of the specific image of the characters “Important” (Step S25).

In Step S24, when the user who wants to change a color clicks the down mark 51a of the color designation window 51, a list of colors that can be selected is displayed in the drop-down menu shown in FIGS. 6A and 6B and the color information of the color of the characters “Important” selected by the user is acquired. When “arbitrary” is selected from the list, the designating panel 55 shown in FIG. 7 is transmitted to the external PC 9 and is then displayed on the monitor. When the user of the external PC 9 inputs, for example, only “cyan”, only “magenta”, or the color mixture ratio of “magenta” and “yellow”, the designated color mixture information (stamp color information) of the characters “Important” is acquired.

Then, the color information adding unit 24 adds the color material information of the specific image, which will be added to the document image and then printed, to the print information on the basis of the acquired color information (Step S28). Then, the process returns to the printing process of the document image and the specific image.

In this way, the image forming apparatus 1 may form the specific image of the characters “Important” added to the document image in a color different from that of the document image while using the same color materials as those of the document image such that the specific image is conspicuous in the document image.

In Steps S11 and S21, the print mode determining unit 21 determines that the print mode is the two-color print mode. However, when one color which is used to print the document image in addition to black includes only one color material, the usable color material determining unit 22 acquires the color material information of one color which is used to print the document image together with black (Step S32). Then, the setting panel 50 shown in FIG. 5 is transmitted to the external PC 9 and is then displayed on the monitor (Step S33). The color of the color material (color material information) acquired in Step S32 is displayed on the color designation window 51 of the setting panel 50 such that the other colors cannot be selected. In this state, when the user of the external PC 9 inputs the position where the specific image is added, the characters “Important”, the font or size of the characters “Important”, and whether to set a border and then clicks the confirmation button (OK) (Step S34), the color information of the used color material is acquired as the print color of the specific image of the characters “Important” (Step S35).

Then, the color setting unit 23 transmits the list 60 with the check box 61 shown in FIG. 8 to the external PC 9 and displays it on the monitor. When the user selects a pattern shape forming the specific image with the check box 61 and clicks the confirmation button (OK) (not shown) (Step S37), the color information adding unit 24 adds the color material information and pattern shape information of the specific image, which will be added to the document image and then printed, to the print information on the basis of the acquired color information and the acquired pattern shape information (Step S28). Then, the process returns to the printing process of the document image and the specific image.

In this way, the image forming apparatus 1 may form the specific image of the characters “Important” added to the document image in a pattern shape having a characteristic pattern or outline so as to be conspicuous in the document image.

In this exemplary embodiment, an interrupt process of forming the specific image in a color different from that of the document image or an interrupt process of forming the specific image in a characteristic pattern shape is performed such that the specific image is conspicuous. However, the invention is not limited thereto, and both the interrupt processes may be performed at the same time.

In this exemplary embodiment, the image forming apparatus performs a series of processes, but the invention is not limited thereto. The PC 9 may perform the series of processes.

The exemplary embodiment of the invention has been described above, but the invention is not limited to the above-described exemplary embodiment. Various modifications and changes of the invention may be made without departing from the scope and spirit of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a two-color printing unit that prints a document image in two colors;
a specific image adding unit that adds a specific image to the document image when the document image is printed in two colors;
a printing unit that performs a printing process with color materials which are used to print the document image and the specific image in two colors; and
an interrupt processing unit that performs an interrupt process of adding print information containing color materials of the specific image different from the document image such that the specific image is conspicuous in the document image before the printing process.

2. The image forming apparatus according to claim 1,
wherein the interrupt processing unit selects a color used in the specific image from a color region which is capable of being formed by the color materials used to print the document image in two colors, adds the print information to be printed, and performs the interrupt process, and
the printing unit performs the interrupt process of adding the print information for printing the specific image in a color designated by the interrupt process.

3. The image forming apparatus according to claim 2,
wherein the interrupt processing unit performs the interrupt process of selecting and designating a color which is capable of printing the specific image and is different from that of the document image, and
the printing unit performs the interrupt process of adding the print information for printing the specific image in the color which is selected and designated by the interrupt process.

4. The image forming apparatus according to claim 1,
wherein the interrupt processing unit performs the interrupt process of adding the print information for printing the specific image in a conspicuous shape, and
the printing unit performs the interrupt process of adding the print information for printing the specific image in a shape subjected to the interrupt process.

5. The image forming apparatus according to claim 2,
wherein the interrupt processing unit performs the interrupt process of adding the print information for printing the specific image in a conspicuous shape, and
the printing unit performs the interrupt process of adding the print information for printing the specific image in a shape subjected to the interrupt process.

6. The image forming apparatus according to claim 3,
wherein the interrupt processing unit performs the interrupt process of adding the print information for printing the specific image in a conspicuous shape, and
the printing unit performs the interrupt process of adding the print information for printing the specific image in a shape subjected to the interrupt process.

7. The image forming apparatus according to claim 1,
wherein the interrupt processing unit acquires the kind of color materials forming the document image, performs the interrupt process of adding the print information for changing the specific image to a conspicuous shape when one kind of color material is used other than black, and performs the interrupt process of adding the print information for printing the specific image in a color which includes two color materials and is different from that of the document image when two kinds of color materials are used other than black.

8. The image forming apparatus according to claim 2,
wherein the interrupt processing unit acquires the kind of color materials forming the document image, performs the interrupt process of adding the print information for changing the specific image to a conspicuous shape when one kind of color material is used other than black, and performs the interrupt process of adding the print information for printing the specific image in a color which includes two color materials and is different from that of the document image when two kinds of color materials are used other than black.

9. The image forming apparatus according to claim 3,
wherein the interrupt processing unit acquires the kind of color materials forming the document image, performs the interrupt process of adding the print information for changing the specific image to a conspicuous shape when one kind of color material is used other than black, and performs the interrupt process of adding the print information for printing the specific image in a color which includes two color materials and is different from that of the document image when two kinds of color materials are used other than black.

10. The image forming apparatus according to claim 4,
wherein the interrupt processing unit acquires the kind of color materials forming the document image, performs the interrupt process of adding the print information for changing the specific image to a conspicuous shape when one kind of color material is used other than black, and performs the interrupt process of adding the print information for printing the specific image in a color which includes two color materials and is different from that of the document image when two kinds of color materials are used other than black.

11. The image forming apparatus according to claim 5,
wherein the interrupt processing unit acquires the kind of color materials forming the document image, performs the interrupt process of adding the print information for changing the specific image to a conspicuous shape when one kind of color material is used other than black, and performs the interrupt process of adding the print information for printing the specific image in a color which includes two color materials and is different from that of the document image when two kinds of color materials are used other than black.

12. The image forming apparatus according to claim 6,
wherein the interrupt processing unit acquires the kind of color materials forming the document image, performs the interrupt process of adding the print information for changing the specific image to a conspicuous shape when one kind of color material is used other than black, and performs the interrupt process of adding the print information for printing the specific image in a color which includes two color materials and is different from that of the document image when two kinds of color materials are used other than black.

13. An image forming method comprising:
adding print information different from a document image before a specific image is printed such that specific image is conspicuous in the document image when an interrupt process, which is a specific image adding process of adding the specific image to the document image and performing printing, is performed in a two-color print mode in which the document image is printed in two colors.

14. A non-transitory computer readable medium storing an image forming program which is stored in a storage unit so as to be readable by an arithmetic unit provided in an image forming apparatus and causes the arithmetic unit to perform:
adding print information different from a document image before a specific image is printed such that specific image is conspicuous in the document image when an interrupt process, which is a specific image adding process of adding the specific image to the document image and performing printing, is performed in a two-color print mode in which the document image is printed in two colors.
